(19) United States
(12) Patent Application Publication
(10) Pub. No.: US 2009/0083282 A1
(43) Pub. Date: Mar. 26, 2009

(54) Work Flow Metadata System and Method

(75) Inventors: Ana Belen Benitez, Los Angeles, CA (US); Marco Vasquez, Los Angeles, CA (US); James Arthur Fancher, Marina Del Rey, CA (US)

Correspondence Address: Robert D. Shedd;Thomson Licensing LLC, PO Box 5312, PRINCETON, NJ, 08543-5312, US

(73) Assignee: THOMSON LICENSING

(21) Appl. No.: 12/085,983

(22) PCT Filed: Jun. 8, 2006
(86) PCT No.: PCT/US2006/022255

§ 371 Date: Jun. 2, 2008

Related U.S. Application Data
(60) Provisional application No. 60/741,997, filed on Dec. 2, 2005.

(51) Int. Cl. G06F 17/30

(52) U.S. Cl. 707/10; 707/104.1; 707/E17.009; 707/E17.032

(57) ABSTRACT

A system for collecting metadata in association with recorded content includes equipment configured to record and process content in the workflow. Metadata collection devices include devices incorporated in the equipment and/or devices configured to externally access the system. The metadata collection devices are configured to collect metadata and associate the metadata with the content at any point and any time in the workflow. The collected metadata can then be used to automate, facilitate and improve content processing in any part of the workflow.

### CROSS-REFERENCE TO RELATED APPLICATIONS

This application claims the benefit of U.S. Provisional Application Ser. No. 60/741,997, filed Dec. 2, 2005, which is incorporated by reference herein in its entirety.

### FIELD OF THE INVENTION

The present invention generally relates to workflow systems and methods and, more particularly, to systems and methods where metadata is collected, managed and exchanged between a plurality of devices at different times in a workflow to contribute to one or more databases for a completed project, e.g., in making a motion picture.

### BACKGROUND OF THE INVENTION

In scenarios were a project requires a group effort, planning and managing the project becomes difficult. The project complexity increases the problems associated with managing the workflow. Traditional project management techniques often required a delegation of small portions of the project to different groups of individuals, which would at some future time compare notes to ensure that the portions fit together to provide for the assembly of project's goal.

Such workflow issues exist in the movie industry. With the complexity of modern motion pictures, multiple crews, special effects teams, etc. make it difficult to manage the workflow and produce a finished product in an efficient and cost effective way. Presently, a problem exists in the recording, collection, exchange, management, and usage of metadata in motion picture creation workflows.

Metadata needs to be recorded and used with appropriate devices at different points in the workflow for automating tasks and making the processes more efficient and mistake-prone. Existing systems for collecting and managing metadata are typically closed and proprietary. In addition, the systems would only cover small portions of a workflow.

Examples of current systems are paper records from the production crew with information about circle takes, camera settings, etc. In addition, some productions have used personal digital assistants (PDAs) for recording circle take information on set. In these PDA-based systems, the circle take information is dumped in a database and never used or accessed after dailies. A circle take is a take the director liked (e.g., well acted, right dialog, good action, etc) and is usually given special attention at dailies and editorial.

In addition, there are some proprietary systems that record camera and set information for visual effects (VFXs) in the ancillary space of High-Definition Serial Digital Interface (HD-SDI) links. However, this metadata is usually short lived since special equipment is needed to read/write it. Therefore, most equipment will ignore and sometimes remove this metadata.

### SUMMARY OF THE INVENTION

An inventive method includes recording content during production of media and associating metadata with the recorded content during media production. Metadata collection devices include devices incorporated in the equipment and/or devices configured to externally access the system. The metadata collection devices are configured to collect metadata and associate the metadata with the content at any point and any time in the workflow. The collected metadata can then be used to automate, facilitate and improve content processing in any part of the workflow. A system for recording and using metadata in a workflow includes at least one recording device capable of collecting content, metadata devices configured to collect metadata associated with the content anywhere in the workflow at anytime, a server configured to receive metadata from the metadata devices at any point in the workflow and store the metadata in a database, and at least one usage device configured to access the server and render the metadata in association with the content throughout the workflow.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 is a block diagram of another illustrative embodiment showing analog and digital cameras recording content and combining the content with metadata for improving the workflow process in accordance with an embodiment of the present invention;

FIG. 2 is a block diagram of another illustrative embodiment showing analog and digital cameras and other equipment reporting metadata to a common database and the database providing the metadata to usage devices in accordance with yet another embodiment of the present invention;

FIG. 3 is a block diagram of another illustrative embodiment showing metadata capture using portable devices which report the metadata to one or more databases and the database(s) providing the metadata to usage devices in accordance with yet another embodiment of the present invention; and

FIG. 4 is a block diagram of another illustrative embodiment showing metadata capture using portable devices which report the metadata to a database server or servers which permit metadata collection and usage to/by devices in the workflow in accordance with yet another embodiment of the present invention.

It should be understood that the drawings are for purposes of illustrating the concepts of the invention and are not necessarily the only possible configuration for illustrating the invention.

### DETAILED DESCRIPTION OF THE INVENTION

The present invention supports collection, management, and usage of metadata at any point of motion picture workflows. Any type of device can be used to record or extract relevant metadata that is collected and made available to other points of the workflows for automating, improving accuracy, facilitating tasks, etc.

It is to be understood that the present invention is described in terms of a metadata collection, management and exchange in the movie industry; however, the present invention is much broader and may include any workflow project in any industry. In addition, the present invention is applicable to a network environment that fosters the entry and usage of metadata in conjunction with the collection and usage of other digital data. The metadata can be recorded by any recording method including recording data taken by telephone, set top boxes, computer, satellite links, computer entry, etc. The present invention is described in terms of a private network; however, the concepts of the present invention may be extended to any wireless and wired network type that may include a public network, a private network or a combination of both.

It should be further understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

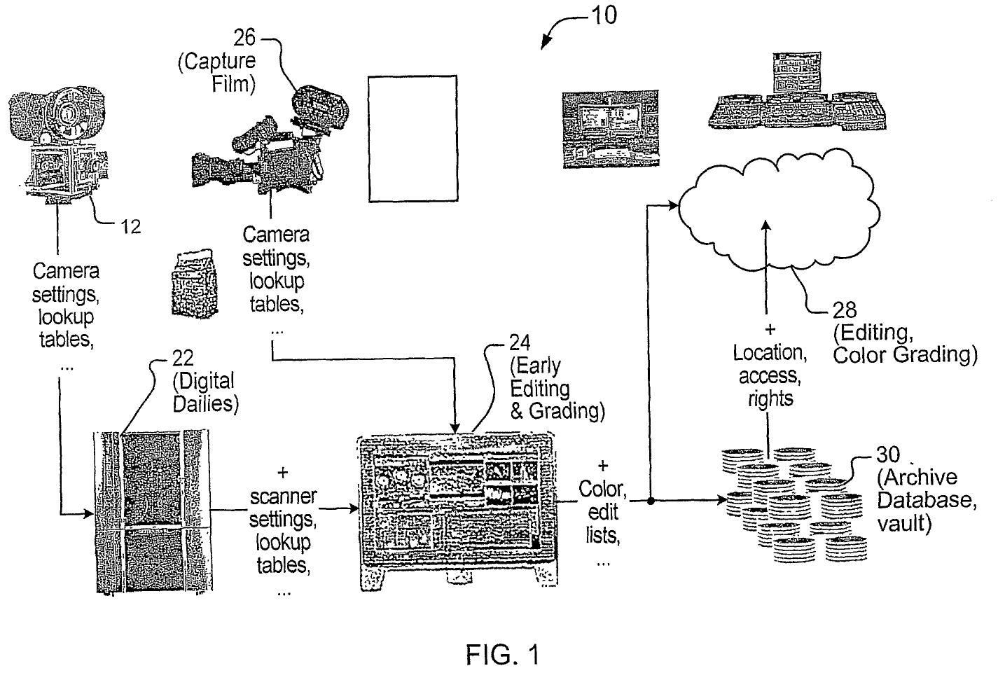

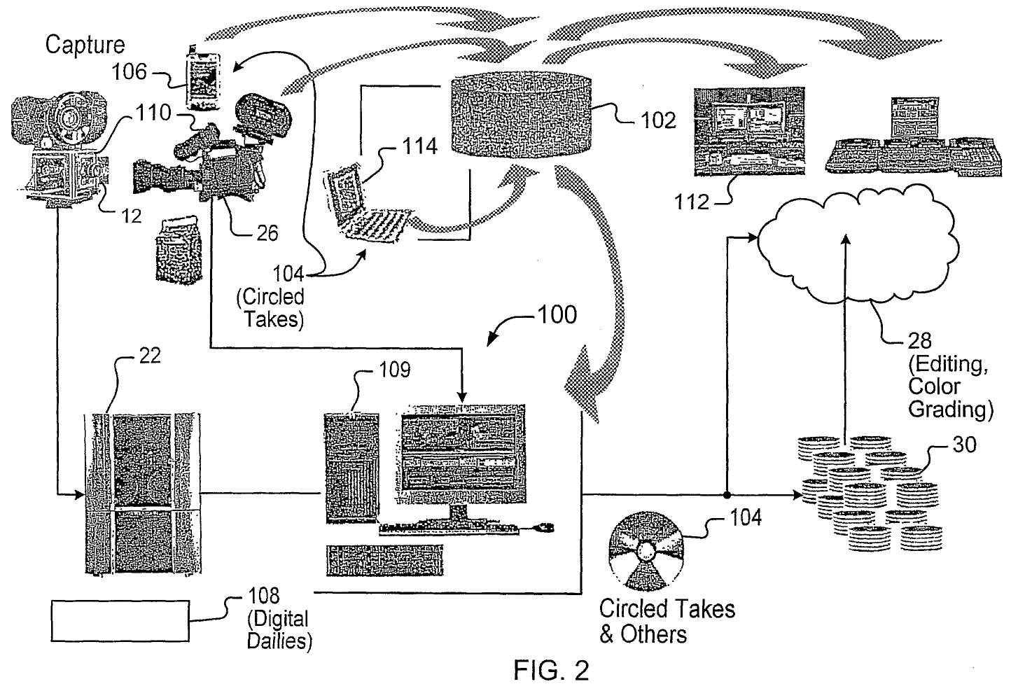

Present principles provide several options for maintaining metadata and content. For example: (1) the metadata could be collected and be transported together with the content (FIG. 1) and/or (2) the metadata could be collected in a separate database or network of database servers (e.g., FIG. 2). In case (2), a unique link between the metadata and the content is maintained, e.g., by employing universal time stamps or unique identifiers. The link could be from the metadata to the content and/or from the content to the metadata.

Referring now in specific detail to the drawings in which like reference numerals identify similar or identical elements throughout the several views, and initially to FIG. 1, an architecture of an illustrative system 10 is shown in accordance with one particularly useful embodiment. The system 10 may include a network of devices capable of communication with at least one database 30. The devices may include a camera or cameras 12 or 26, processors (e.g. a datacine processor 22 for dailies processing and viewing, computers or other viewing/editing equipment 24, etc. These devices either record or use workflow metadata. The devices may include a capability for recording content, and metadata may be combined with the content.

For example, in the case of a camera 12, image data is collected for a scene during filming. Simultaneously with the filming or at a different time, data may be automatically acquired or entered by a user or other device to be recorded with the content or at least associated with the content in the form of metadata. The metadata may include camera settings, lookup tables for images (e.g., color correction information or the like), or any other information that could be useful for the production and/or editing of a film.

The content and metadata from the camera may be reported directly to a physical vault or database 30 or passed on to a next stage in the processing of the film (or digital media), e.g., digitizing of the film or early processing using a datacine processor 22. Processor 22 may employ the content and/or the metadata to enhance the datacine (digitizing) processing of the film from camera 12. In addition, the datacine processing 22 may provide new metadata or augment the old metadata with e.g., scanner settings, lookup tables, or other useful data. The metadata enhanced (e.g., accumulated metadata from all previous processes) content may then be sent or provided to a next processing stage. As before, the metadata can be provided directly to a database 30 or included with the content or edited content for the next stage in the workflow.

In the example shown in FIG. 1, a review of the content, e.g., a dailies viewing may be performed using a television, display or projector at equipment 22 or 24. Equipment 24 may include the ability to edit the content and/or provide notes related to the content, preferably in the form of metadata. E.g., color decisions and changes, edit lists, scene information or ratings, etc. may be included in the metadata. The entire content with metadata may be stored in the database 30 and/or provided to editing equipment 28. The editors will have at their disposal all of the metadata information collected at all stages of the work flow. This information can be searchable from the database 30 and can be indexed to each scene or frame. The database 30 may provide an opportunity to add other metadata. E.g. information on access rights, security levels and location information can be added to the content or separated stored and associated with the content.

System 10 may include a digital camera 26 which may be used instead of or in addition to a film camera 12 for recording image content. Film or digital media may be employed to record metadata taken at the time of filming which is related to the filming process. Alternately, metadata may be associated with the film scenes or frames and recorded directly to an archive or database 30.

Film from camera 12 may include the metadata, such as camera settings, lookup tables, etc., or the metadata based on notes or other collected information may be introduced or associated with content when the film is converted to digital information with equipment 22. Equipment 22 may include processing equipment, e.g., for viewing and editing dailies. When the film is converted, the metadata may be placed directly in with the content and forwarded to a next stage. Alternately, the metadata may be sent to archive 30 directly.

Early editing equipment 24 may be employed for grading, editing scenes and otherwise enhancing the content. Equipment 24 may receive digital content from digital camera 26 and/or digital content from equipment 22. Equipment 24 may also receive the metadata from camera 26 (e.g., camera settings, lookup table, etc.) and from equipment 22. Equipment 24 changes or adds additional metadata (e.g. color information, edit lists, etc.) to the content (or provides the metadata directly to the archive). All the metadata previously added in the workflow is provided to the editors (or others accessing the information) of the motion picture of feature. Editing equipment 28 uses the content and metadata to better organize the content and make corrections based upon recorded information. The archive 30 also may provide metadata (e.g., access rights and location information for stored metadata).

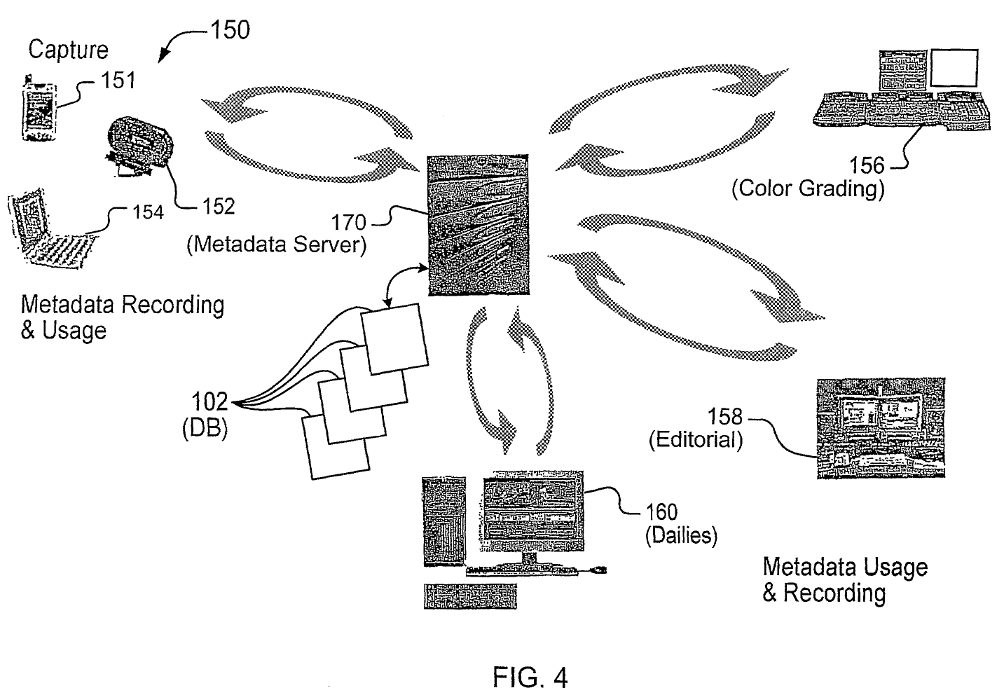

Referring to FIG. 2, a distributed network 100 includes a database 102 in communication with a plurality of metadata sources. The network 100 is composed of devices that record and/or use workflow metadata. In other embodiments (e.g., in FIG. 4) a network of metadata servers are provided that collect, manage and publish the metadata. Any type of workflow metadata could be supported including circle takes, camera position, camera settings, set dimensions, etc. For example, for each scene and take, metadata could be collected by different devices including circled take information 104 or other information (e.g., with a PDA 106, laptop 114, processing equipment 108, etc.). Color corrections (e.g., through laptop manipulation), camera position (e.g., using a camera 12 or 26 or sensors 110 attached to a camera), etc.

The system can acquire, collect and manage metadata that is relevant from the point of view of a director, a cinematographer, a VFX supervisor, a camera operator, an editor, a colorist, etc. Examples of metadata recording devices may include PDAs, cellphones, laptop, sensors, cameras, recorders, etc. In addition, editing or processing equipment may add metadata to the content or the database. The system 100 permits the downloading of metadata recording applications (such as in Java, C++, etc) to any device with Internet access, wireless network access, or other type of connection. In this way, completely different devices (that may be different PDA, camera, computer, etc.) may be used in the data acquisition phase. These different metadata recording devices then may be used by different parties to input metadata about the same event, at the same time. For example, a director and a special effects worker may input metadata about a scene at the same time. This metadata is then made available at any other stage through a database 102 or a server (See FIG. 4) for post production, dailies, or any other operation performed during the process. Examples of devices that can use the metadata may include a dailies station 108, which may include a processing station 109 and a digital conversion station 22 (for converting an analog film recording), an editorial station 28, color correction station 112, etc.

In accordance with the embodiment shown in FIG. 2, metadata information may be reported to and stored in database 102. The information may be reported to the database 102 using a plurality of different devices and a plurality of different modes. The data base 102 may include a plurality of security levels and the users of the data base may not be privy to all of the metadata information stored therein. For example, a director may have access to all of the data while a cinematographer may only have access to a portion of the data. The data in database 102 may be organized in a plurality of different ways. Some examples of database organization include: organized by date and time, organized by scene or frame number, organized by author or title, etc. In a preferred embodiment, communication with the database is performed over a secured wireless network, although a secured Internet or other network is also adequate. In this way, metadata is easily stored and easily accessible to authorized users. Metadata can be collected using any available device capable of communication with or adapted to communicate with database 102.

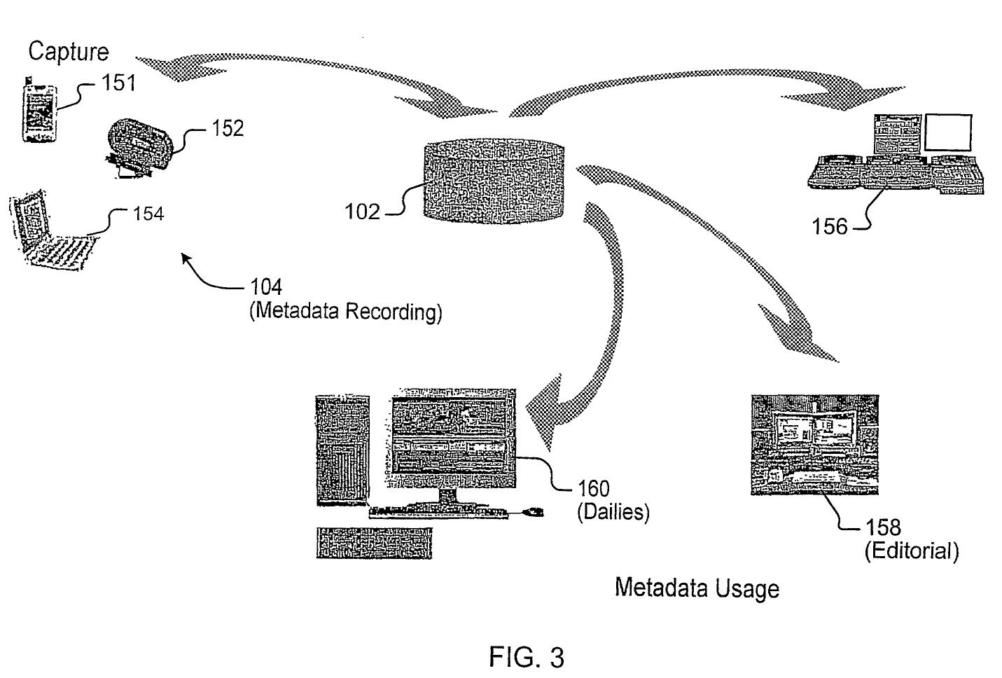

Referring to FIG. 3, a schematic diagram shows metadata collection and usage in accordance with one embodiment. Metadata collected from the field or on set is, stored in a database 102 and can be accessed by other parts of the workflow at any time and place through a network. During a project, such as, the making of a motion picture, workers are equipped with communication devices 150 for inputting metadata into a database (or alternately recording the metadata with the content recording media (e.g., film, memory, etc.). The communication devices 150 may include a PDA 151, a cellular telephone, 152, a laptop computer 154 or similar devices. In addition, all other equipment may be provisioned to permit the entry and access of metadata. Users of the devices may call up a form or a formatted page and enter data or measurements into the form. A form is not necessary and any data entry may be recorded as metadata by simply providing access to memory in the database 102 or to the content media. The metadata is recorded to database 102 by transmitting the data to the database 102 along with identification information or at least one of date/time, sender's identification, scene data, or any other acceptable information which may be employed to correlate the metadata to the content being recorded or edited. The database 102 organizes the metadata to permit authorized access by one or more devices, which will employ the metadata. Devices that may benefit from access to the metadata include, e.g., color grading equipment 156, editorial equipment 158, daily editing equipment 160, etc.

Referring to FIG. 4, in another embodiment, the metadata recorded in database 102 may also be accessible to authorized users in the workflow. Now any part of the workflow can actually collect metadata, use the metadata and/or transmit the metadata to a metadata server 170 or other user for that metadata to be accessible by any authorized person or device. Database 102 may be included with or work in conjunction with one or more servers 170. For example, an authorized film worker may check notes from another worker to determine how a current task would be affected by downloading metadata from server 170. Other interactive features and mechanisms may be employed as well. For example, the metadata may be stored with a ranking describing an importance of a metadata message or note. In one embodiment, the metadata notes may automatically appear on a screen or display when a triggering event such as accessing a file is performed. One of the metadata servers 170 could act as a master and central server to which the rest of the metadata servers 170 report to and synchronize from.

The exchange of metadata between metadata servers 170 and devices 150, 156, 158, 160, etc. may be performed through open, standard Web Services and protocols (e.g., XML, RPC and SOAP). Web services are platform independent so the present invention can work in heterogeneous computing environments (e.g., the PDA could be C++ on Windows CE™; whereas the metadata server 170 could run Java™ on Linux™).

One illustrative embodiment has been constructed and simulated, and includes a PDA used to record circle take metadata. Web services through a wireless connection were employed to send the metadata to a mobile metadata server (a laptop). A dailies station accessed the circle take metadata using a web browser. The circle take metadata was used by the dailies station to create a CD that distinguished between circle takes and other takes.

Present principles also provide a schema where the creation of metadata for a scene, may be synchronized between different devices. For example, a SMPTE time code may be used to link metadata produced by a PDA to metadata produced by a camera. It is also envisioned that other methods for synchronization may be used, such as, by employing a master clock, and the like. By synchronizing different devices, the manual entry of each event (such as entering in scene 5, scene 6, etc.) would not be necessary for every device. It is also contemplated that although descriptive terms like “scene” and “take” may be used to describe a particular event and its associated metadata, other objects may be used to describe an event. For example, a person editing a film may find a certain circle take by requesting that the metadata server render a screen that indicates circles with a graphic element using a thumbnail image from the circle take. Hence, a person who is looking for a particular event may use both textual and graphic elements to identify a scene/take of interest. Database 102 may include a network of databases that keep the metadata synchronized with each other and accessible by any authorized person and anywhere (even where no Internet connection may be available). The database may be distributed among and between the devices in the network. The network may be set up for a specific project and the metadata may be collected, managed and stored by a plurality of distributed databases. A synchronization protocol, e.g., time stamping and a system of unique identifiers may be put in place to provide authorization/access control and permit updated information to be accessible and apparent to users. The time stamps or unique identifiers may be employed to link content with respective metadata and vice versa.

While present principles are described for a filmmaking project, such projects are for illustrative purposes. The present invention is equally applicable to other projects and workflows where metadata notes and equipment may be employed to permit an improved product. For example, metadata collection and usage may be useful in a manufacturing environment where electronic records of a product are maintained throughout an assembly or manufacturing process. Other examples may include the production or recording or portable media such as compact disks, DVDs, etc.

Having described preferred embodiments for a work flow metadata system and method (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method comprising the steps of:
recording content;
collecting metadata generated in association with the content recording;
associating the metadata with the content; and
utilizing the associated metadata to manipulate the content.

2. The method of claim 1 further comprising:
collecting the metadata for association by one of a cellular telephone, a laptop computer, a sensor and a personal digital assistant.

3. The method of claim 1 further comprising:
recording content utilizing a camera; and
collecting camera settings for association by one of a cellular telephone, a laptop computer, a sensor and a personal digital assistant.

4. The method of claim 1 further comprising:
employing a workflow for metadata that includes a plurality of processing operations wherein each processing receives the content and the metadata from a previous processing operation.

5. The method claim 4 further comprising:
employing the metadata from a previous process operation in a current processing.

6. The method of claim 5 further comprising:
utilizing the current processing operation to provide current processing metadata to the content.

7. The method of claim 1 further comprising:
reporting the metadata to a database.

8. The method of claim 1 further comprising:
associating the metadata with the content to enable processing of the content throughout media production.

9. The method of claim 1 further comprising:
collecting metadata from at least one of content editing, color grading and daily viewing processes.

10. The method of claim 1 further comprising:
accumulating the metadata in association with the content throughout media production.

11. The method of claim 1 further comprising:
storing the metadata directly with the content.

12. The method of claim 1 further comprising:
storing the metadata throughout a workflow in a database.

13. The method of claim 12 further comprising:
utilizing a network of databases as the database.

14. The method of claim 12 further comprising:
utilizing time stamped and uniquely identified metadata entries to link content with respective metadata.

15. The method of claim 1 further comprising:
utilizing the metadata to automate, facilitate and improve content processing in a workflow.

16. A system for recording and using metadata in a workflow, comprising:
at least one recording device capable of collecting content;
metadata devices configured to collect metadata associated with the content in the workflow;
a server configured to receive metadata from the metadata devices in the workflow and store the metadata in a database; and
at least one usage device configured to access the server and render the metadata in association with the content throughout the workflow.

17. The system as recited in claim 16, wherein the metadata device includes one of a cellular telephone, a laptop computer, a sensor, processing equipment and a personal digital assistant.

18. The system as recited in claim 16, wherein the recording device includes a camera and the metadata includes camera settings.

19. The system as recited in claim 16, wherein the workflow includes a plurality of processes wherein each process receives the content and the metadata from a previous process.

20. The system as recited in claim 19, wherein the metadata from a previous process is employed in a current process.

21. The system as recited in claim 20, wherein the current process provides current process metadata to the content.

22. The system as recited in claim 19, wherein the metadata is directly reported to the database in association with each of the plurality of processes.

23. The system as recited in claim 16, wherein the at least one usage device includes at least one of a content editing device, a color grading device, and a daily viewing device.

24. The system as recited in claim 16, wherein the metadata is accumulated in association with the content throughout the workflow.

25. The system as recited in claim 16, wherein the metadata is stored directly with the content.

26. The system as recited in claim 16, wherein the database includes a network of databases.

27. The system as recited in claim 16, wherein at least one of the database and the content include specifically identified and time stamped metadata entries used to link content with respective metadata.

28. The system as recited in claim 16, wherein the metadata is used to automate, facilitate and improve content processing in any part of the workflow.

29. A system for recording and using metadata in a movie production, comprising:
a camera configured to collect content;
processing equipment configured to record and process the content in the production; and
metadata collection devices including at least one of devices incorporated in the processing equipment and camera, and devices configured to externally access the system, the metadata collection devices being configured to collect metadata and associate the metadata with the motion picture content at any point and any time in the production and record the metadata in one of a metadata database and directly on the content.

30. The system as recited in claim 29, further comprising a processing device configured to access a database and render the metadata in association with the motion picture content wherein the metadata provides, throughout the production, processing directions and comments synchronized with the content.

31. The system as recited in claim 30, wherein the processing device includes at least one of a content editing device, a color grading device, and a daily viewing device.
